(19) United States
(12) Patent Application Publication
(10) Pub. No.: US 2026/0152422 A1
(43) Pub. Date: Jun. 4, 2026

(54) METHOD OF PHOTOCATALYTIC REDOX REACTION BASED ON STRUCTURED LIGHT ILLUMINATION AND DEVICE THEREOF

(71) Applicant: SHANDONG NORMAL UNIVERSITY, Jinan (CN)

(72) Inventors: Bo TANG, Jinan (CN); Lu LI, Jinan (CN); Simin LI, Jinan (CN)

(21) Appl. No.: 19/004,646

(22) Filed: Dec. 30, 2024

(30) Foreign Application Priority Data
Dec. 3, 2024 (CN) 2024117642447

(51) Int. Cl. C02F 1/72; B01J 23/22; B01J 23/50; B01J 35/33; B01J 35/39; C02F 1/00; C02F 1/32; C02F 1/70

(52) U.S. Cl. CPC C02F 1/725; B01J 23/22; B01J 23/50; B01J 35/33; B01J 35/39; C02F 1/008; C02F 1/325; C02F 1/70; C02F 2305/10

(57) ABSTRACT

The present invention provides a device of photocatalytic redox reaction based on structured light illumination, comprising: a computer module, sending control instructions to structured light generation module and image acquisition module, to control generations of structured illumination field and total internal reflection illumination field, and acquisition of images of single-molecule fluorescence; the structured light generation module, comprising lasers, an acousto-optic tunable filter (AOTF) and a spatial light modulator (SLM), and controlling the lasers, the AOTF and the SLM to generate and regulate the structured illumination field for exciting a photocatalytic redox reaction, and generate and regulate the total internal reflection illumination field for exciting the single-molecule fluorescence; and, the image acquisition module, acquiring images of fluorescence signals in a process of the photocatalytic redox reaction.

### CROSS-REFERENCE TO RELATED APPLICATIONS

The present invention claims priority benefits to Chinese patent application No. 202411764244.7, entitled “A Method of Photocatalytic redox reaction Based on Structured Light Illumination and Device Thereof”, filed on Dec. 3, 2024, with the China National Intellectual Property Administration (CNIPA), the entire contents of which are incorporated herein by reference and constitute a part of the present invention for all purposes.

### TECHNICAL FIELD

The present invention belongs to the technical field of energy photochemistry and environmental photochemistry, and particularly relates to a method of photocatalytic redox reaction based on structured light illumination and a device thereof.

### BACKGROUND

The statements in this section merely provide background information related to the present invention and do not necessarily constitute prior art.

Nowadays, the development of society is facing more and more serious problems of energy shortage and environmental pollution. Green semiconductor photocatalytic technology is considered as an important means to break through the current dilemma. In the semiconductor photocatalytic redox reaction, the catalyst absorbs light energy to generate free electrons and holes, which are transferred to the surface, and the catalyst and oxidation-reduction reactions (redox reactions) occurs between those free electrons and holes with substances adsorbed on the surface; this method can be used to decompose aquatic hydrogen or oxidize and degrade organic pollutants. However, photogenerated carriers are easy to recombine in the process of migration to the surface and participate in redox reactions, resulting in most of the light energy being wasted. The low utilization rate of light energy makes it difficult to promote and apply photocatalytic technology. At present, catalyst structure modification is an effective method to improve photocatalytic efficiency, including noble metal deposition, ion doping, construction of heterojunction, etc., but the construction of complex structure catalysts will not only increase the cost, but also reduce the long-term stability of the material. Another method to improve catalytic efficiency is to apply external field regulation, including electric field, magnetic field, and microwave field and so on. External field regulation can inhibit recombination of the photogenerated carriers and drive the separation of photogenerated electron-hole pairs inside and on the surface of the catalyst, which can improve catalytic performance without changing the structure of the semiconductor catalyst. However, external field will also consume a lot of extra energy. How to efficiently promote the separation of the photogenerated carriers and suppress the recombination of the electron-hole pairs is still an important problem to be solved.

### SUMMARY

In order to promote that separation of photogenerated electrons and holes in semiconductor catalyst and improve the conversion efficiency of photocatalytic redox reaction, the present invention provides a method of photocatalytic redox reaction based on structured light illumination and a device thereof, exciting and generating spatially non-uniform distributed photogenerated carriers by using structured light illuminated catalysts, and inducing the formation of space charge fields. Research has shown that these space charge fields can improve the separation efficiency of photogenerated electrons and holes, thereby enhancing the catalytic activity of the catalyst itself. In addition, the catalytic reaction process on the surface of catalyst particles may be monitored in real time through the method and device disclosed by the present invention, which may reveal the interaction mechanism between structured illumination field and semiconductor nanoparticles, and provide a non-modification and low-energy consumption method to improve the catalytic activity of semiconductor photocatalyst.

According to some examples, a first aspect of the present invention provides a device of photocatalytic redox reaction based on structured light illumination, which adopts the following technical solutions.

The device of photocatalytic redox reaction based on structured light illumination, comprising:
a computer module, being configured to send control instructions to a structured light generation module and an image acquisition module, to control generations of a structured illumination field and a total internal reflection illumination field, and acquisition of images of single-molecule fluorescence;
the structured light generation module, comprising a plurality of lasers, an acousto-optic tunable filter (AOTF) and a spatial light modulator (SLM), and being configured to control the plurality of lasers, the AOTF and the SLM according to the control instructions sent by the computer module, to generate and regulate the structured illumination field for exciting a photocatalytic redox reaction, and generate and regulate the total internal reflection illumination field for exciting the single-molecule fluorescence; and
the image acquisition module, being configured to acquire images of fluorescence signals in a process of the photocatalytic redox reaction.

Further, the computer module sends synchronization signals generated by a synchronization controller to the structured light generation module and the image acquisition module, to synchronize the structured light generation module and the image acquisition module.

Further, the structured light generation module comprises a first optical path formed by sequentially connecting a first light-source submodule comprising a first laser, a first reflecting mirror, a first dichroic mirror, a second reflecting mirror, and a second dichroic mirror connected sequentially, and the AOTF, a half-wave plate, a third dichroic mirror, a first polarization beam splitter prism, the SLM, a first lens, a third reflecting mirror, a fourth reflecting mirror, a second lens, a fifth reflecting mirror, a second polarization beam splitter prism, a first tube mirror, a fourth dichroic mirror, an objective lens and a photocatalytic redox reaction pool; wherein, the first light path is used for generating and regulating the structured illumination field and triggering the photocatalytic redox reaction in the photocatalytic redox reaction pool.

Further, the structured light generation module further comprises a second optical path formed by sequentially connecting a second light-source submodule comprising a second laser, the first dichroic mirror, the second reflecting mirror, and the second dichroic mirror connected sequentially, and the AOTF, the half-wave plate, the third dichroic mirror, a sixth reflecting mirror, a seventh reflecting mirror, the first tube mirror, the fourth dichroic mirror, the objective lens and the photocatalytic redox reaction pool; wherein the second optical path is used for generating and regulating the total internal reflection illumination field.

Further, the structured light generation module further comprises a third optical path formed by sequentially connecting a third light-source submodule comprising a third laser and the second dichroic mirror connected sequentially, and the AOTF, the half-wave plate, the third dichroic mirror, the sixth reflecting mirror, the seventh reflecting mirror, the first tube mirror, the fourth dichroic mirror, the objective lens and the photocatalytic redox reaction pool; wherein, the third optical path is used for generating and regulating the total internal reflection illumination field for exciting fluorescent molecules in the reactants or the products; wherein, the wavelengths of the total internal reflection illumination field generated by the third optical path and the second optical path are not consistent.

Further, the synchronization controller sends a triggering signal to the SLM, the SLM loads a phase modulation function stored in a storage module inside the SLM according to a predetermined timing sequence, and outputs a synchronous control signal to the synchronous controller, and then the computer module generates signals to a camera and the lasers based on the synchronous control signal received by the synchronous controller, to carry out sample excitation and image acquisition.

Further, the image acquisition module comprises a fourth optical path formed by sequentially connecting the photocatalytic redox reaction pool, the objective lens, the fourth dichroic mirror, a second tube lens and an image detector; wherein,
the objective lens, the fourth dichroic mirror and the second tube lens are parts of an inverted microscope.

Further, the first light-source submodule, the second light-source submodule, the third light-source submodule and the AOTF constitute a multi-wavelength laser light-source module, and an intensity and an illumination time sequence of a multi-wavelength laser beam comprising laser lights with different wavelengths and being generated by the multi-wavelength laser light-source module are adjusted by the AOTF; and
the AOTF outputs the multi-wavelength laser beam after intensity adjustment to the third dichroic mirror for separating the laser lights with different wavelengths; wherein
one wavelength of laser light is separated out and enters vertically the SLM through the first polarization beam splitter prism for modulating, and the modulated laser light is used to generate the structured light; and remaining wavelengths of laser lights maintain a uniform light state without being modulated.

Further, the modulated laser light enters the image acquisition module through the first optical path of the structured light generation module after modulation, to form a structured illumination field near an object plane of a microscope, and irradiates a catalyst to generate electrons and holes to trigger the photocatalytic redox reaction.

Further, in the photocatalytic redox reaction, at least one reactant or product is a fluorescent substance, the fluorescent substance may emit fluorescence by exciting by the total internal reflection illumination light, the microscope collects the emitted fluorescence and generate fluorescence signals, and transmits the generated fluorescence signals to the image detector through the fourth dichroic mirror and the second tube lens, to form fluorescence images of a single-molecule redox reaction.

According to some examples, a second aspect of the present invention provides a working method of a device of photocatalytic redox reaction based on structured light illumination, which adopts the following technical solutions.

The working method of the device of photocatalytic redox reaction based on structured light illumination according to the first aspect, comprising:
placing a particulate semiconductor catalyst and a reactant in an object space of a microscope and contacting the catalyst and the reactant;
irradiating the catalyst by a structured light generated by a structured light generation to trigger a photocatalytic redox reaction; and
exciting the reactant or reaction products to emit fluorescence, collecting single-molecule fluorescence signals through an image acquisition module and outputting images.

Compared with the prior art, the present invention has the beneficial effects that:

According to the present invention, the method of photocatalytic redox reaction based on structured light illumination, may promote effective separation of photogenerated carriers of a catalyst in space and improve photocatalytic redox reaction efficiency. According to the present invention, based on the constructed reaction device, the investigation on the influence of structured light illumination on the surface interface reaction activity of semiconductor catalyst particles may be carried out, which may reveal the influence of structured light on the surface reaction activity and kinetics of catalyst particles; and the system provides a powerful tool for investigating the photocatalytic redox reaction activity of single particle regulated by light field.

### BRIEF DESCRIPTION OF THE DRAWINGS

The accompanying drawings constituting a part of the present invention are used to provide a further understanding of the present invention. The exemplary examples of the present invention and descriptions thereof are used to explain the present invention, and do not constitute an improper limitation of the present invention.

FIG. 1 is an overall structural diagram of a device of photocatalytic redox reaction based on structured light illumination according to an example of the present invention;

FIG. 2 is an optical path diagram of the device of photocatalytic redox reaction based on structured light illumination according to an example of the present invention;

FIG. 3 shows images of fringe structured illumination fields with different period widths generated in an example of the present invention;

FIG. 4A is a statistical chart of electron reaction frequency of BiVO4/Ag2O under uniform light and structured light illumination, respectively;

FIG. 4B is a statistical chart of hole reaction frequency of BiVO4/Ag2O under the uniform light and the structured light illumination, respectively;

FIG. 5 is a schematic diagram of the structured light illumination promoting separation of photogenerated electrons and holes of a catalyst in space according to an example of the present invention.

### DETAILED DESCRIPTION

The present invention will now be further described with reference to the accompanying drawings and examples.

It should be pointed out that the following detailed descriptions are all illustrative and are intended to provide further descriptions of the present invention. Unless otherwise specified, all technical and scientific terms used in the present invention have the same meanings as those usually understood by a person of ordinary skill in the art to which the present invention belongs.

It should be noted that the terms used herein are merely used for describing specific implementations, and are not intended to limit exemplary implementations of the present invention. As used herein, the singular form is also intended to include the plural form unless the context clearly dictates otherwise. In addition, it should further be understood that, terms “comprise” and/or “comprising” used in this specification indicate that there are features, steps, operations, devices, components, and/or combinations thereof.

The examples and the features of the examples in the present invention may be combined with each other without conflict.

### Example 1

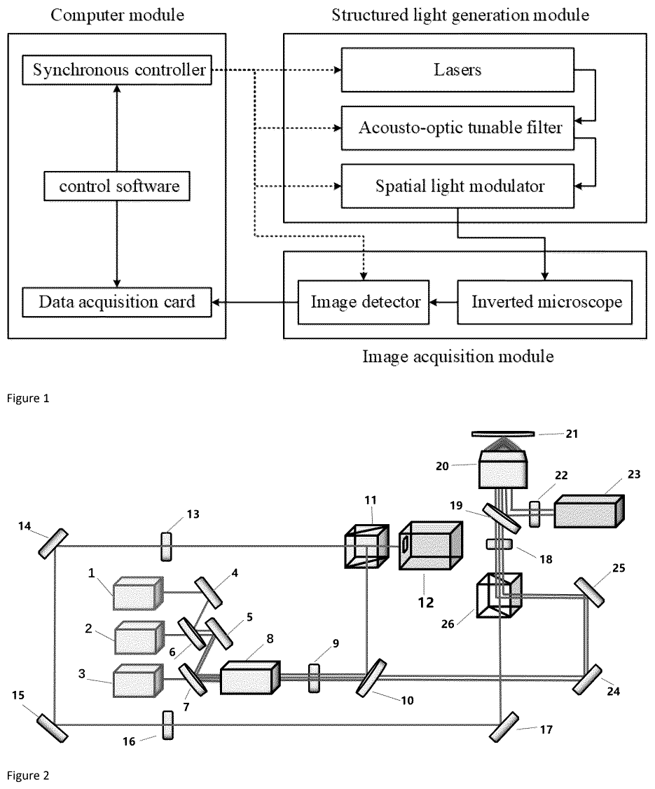

As shown in FIG. 1, the present example provides a device of photocatalytic redox reaction based on structured light illumination, comprising:
a computer module, being used for carrying out hardware control and image storage, and running analysis software, and being configured to send control instructions to a structured light generation module and an image acquisition module, to generate a structured illumination field and a total internal reflection illumination field, and to acquire single molecule fluorescence images;
the structured light generation module, comprising lasers, an AOTF and a SLM, being configured to control the lasers, the AOTF and the SLM according to the control instructions sent by the computer module, to generate and regulate the structured illumination field for exciting a photocatalytic redox reaction, and generate and regulate the total internal reflection illumination field for exciting the single-molecule fluorescence.

As shown in FIG. 2, the structured light generation module comprises a first light path formed by sequentially connecting a first light-source submodule comprising a first laser 1, a first reflecting mirror 4, a first dichroic mirror 6, a second reflecting mirror 5, and a second dichroic mirror 7 connected sequentially, and an AOTF 8, a half-wave plate 9, a third dichroic mirror 10, a first polarization beam splitter prism 11, the SLM 12, a first lens 13, a third reflecting mirror 14, a fourth reflecting mirror 15, a second lens 16, a fifth reflecting mirror 17, a second polarization beam splitter prism 26, a first tube mirror 18, a fourth dichroic mirror 19, an objective lens 20 and a photocatalytic redox reaction pool 21; wherein, the first light path is used for generating and regulating the structured illumination field and triggering the photocatalytic redox reaction in the photocatalytic redox reaction pool.

As shown in FIG. 2, the structured light generating module further comprises a second optical path formed by sequentially connecting a second light-source submodule comprising a second laser 2, the first dichroic mirror 6, the second reflecting mirror 5, and the second dichroic mirror 7 connected sequentially, and the AOTF 8, the half-wave plate 9, the third dichroic mirror 10, a sixth reflecting mirror 24, a seventh reflecting mirror 25, the first tube mirror 18, the fourth dichroic mirror 19, the objective lens 20, and the photocatalytic redox reaction pool 21; wherein, the second light path is used for generating and regulating the total internal reflection illumination field for exciting fluorescent molecules in reactants or products; wherein, the AOTF adjusts wavelength and intensity of laser; and, the structured illumination field and the total internal reflection illumination field have different wavelengths and are coupled together through the second beam splitter prism for transmission on a common optical axis.

As shown in FIG. 2, the structured light generating module further comprises a third optical path formed by sequentially connecting a third light-source submodule comprising a third laser 3 and the second dichroic mirror 7 connected sequentially, and the AOTF 8, the half-wave plate 9, the third dichroic mirror 10, the sixth reflecting mirror 24, the seventh reflecting mirror 25, the first tube mirror 18, the fourth dichroic mirror 19, the objective lens 20 and the photocatalytic redox reaction pool 21; wherein, the third optical path is used for generating and regulating the total internal reflection illumination field for exciting fluorescent molecules in the reactants or the products; it can be understood that the wavelengths of the total internal reflection illumination field generated by the third optical path and the second optical path are not consistent.

As shown in FIG. 2, the image acquisition module comprises a fourth optical path formed by sequentially connecting the photocatalytic redox reaction pool 21, the objective lens 20, the fourth dichroic mirror 19, a second tube lens 22 and an image detector 23, and is used to collect fluorescence signals to image the single-molecule redox reaction process in the catalytic reaction process;
wherein, the objective lens, the fourth dichroic mirror and the second tube lens are structures in an inverted microscope.

The computer module is connected with the image acquisition module through an image acquisition card so as to receive signals of the image acquisition module.

The computer module sends synchronization signals generated by a synchronization controller to the structured light generation module and the image acquisition module, to synchronize the two modules.

The synchronization controller sends a triggering signal to the SLM, the SLM loads a phase modulation function stored in a storage module inside the SLM according to a predetermined timing sequence, and outputs a synchronous control signal to the synchronous controller, and then the computer module generates signals to a camera and the lasers based on the synchronous control signal received by the synchronous controller, to carry out sample excitation and image acquisition.

The first light-source submodule, the second light-source submodule, the third light-source submodule and the AOTF constitute a multi-wavelength laser light-source module, may generating a multi-wavelength laser beam comprising laser lights with different wavelengths of which a wavelength range of 350-800 nm, and an intensity and an illumination time sequence of the multi-wavelength laser beam are adjusted by the AOTF;
the AOTF outputs the multi-wavelength laser beam after intensity adjustment to the third dichroic mirror for separating the laser lights with different wavelengths; wherein
one wavelength of laser light is separated out and enters vertically the SLM through the first polarization beam splitter prism for modulating, and the modulated laser light is used to generate the structured light; and remaining wavelengths of laser lights maintain a uniform light state without being modulated.

The SLM is used to modulate an incident laser light, wherein the modulated laser light enters the microscope of the image acquisition module through optical elements such as lens and reflecting mirrors in the first optical path, to form the structured illumination field near the object plane of the microscope, and irradiates the catalyst to generate electrons and holes to trigger the photocatalytic redox reaction.

In some examples, in the photocatalytic redox reaction, at least one reactant or product is a fluorescent substance, the fluorescent substance may emit fluorescence by exciting by the total internal reflection illumination light, the microscope 20 collects the emitted fluorescence and generate fluorescence signals, and transmits the generated fluorescence signals to the image detector 23 through the fourth dichroic mirror 19 and the second tube lens 22, to form fluorescence images of a single-molecule redox reaction.

### Example 2

The present example provides a working method of a device of photocatalytic redox reaction based on structured light illumination described in Example 1, comprising:
placing a particulate semiconductor catalyst and a reactant in an object space of a microscope and contacting the catalyst and the reactant;
irradiating the catalyst by a structured light generated by a structured light generation to trigger a photocatalytic redox reaction; and
exciting the reactant or reaction products to emit fluorescence, collecting single-molecule fluorescence signals through an image acquisition module and outputting images.

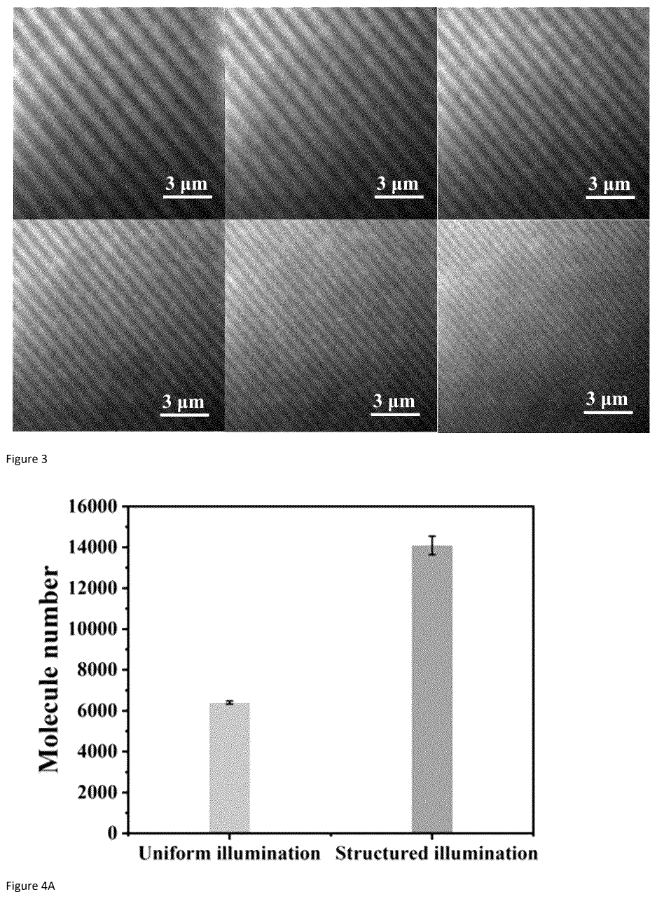

Description below according to specific examples, comprising:
1) In the present example, a catalytic light source is modulated into a structured light by a SLM. The selection of wavelength of the catalytic light source depends on the energy band width of the catalyst; in the present example, the catalytic light source is a laser of wavelength of 405 nm. In the present example, the structured light is a two-dimensional cosine light field, as shown in FIG. 3, various illumination fields with different periods are actually measured, and the minimum period can reach 216 nm.
2) In the present example, a semiconductor catalyst was selected, specifically, the decahedral bismuth vanadate (BiVO₄) surface-modified with silver oxide (Ag₂O) was used as the catalyst, and a synthesis method was as follows:
firstly, dissolving 1.46 g bismuth nitrate pentahydrate in 30 ml nitric acid solution with concentration of 1 mol/L, magnetic stirring for 30 min to fully dissolve it; adding 0.35 g ammonium metavanadate to the solution and stirring for 1 h; adjusting pH value of the solution to 1.25 with ammonia water, after aging for 30 min, transferring the precipitate to polytetrafluoroethylene synthesis kettle with capacity of 100 mL, and carrying out hydrothermal reaction at 100° C. for 48 h; cooling the synthesis kettle to room temperature, taking out the material, washing with deionized water, transferring the washed material to a drying oven at 60° C., drying for 12 h, then obtaining the decahedral BiVO₄ nano-crystals. Then, weighting 50 mg of decahedral BiVO₄ and dispersing in 30mL of deionized water; after ultrasonic dispersion for 30 min, adding 10 mg of AgNO₃ and stirring for 30 min, then putting the mixture into a metal bath and evaporating while stirring; after the solution was completely evaporated, collecting the product and washing with deionized water, and transferring to a drying oven at 60° C. for drying for 12 h. Finally, the BiVO₄/Ag₂O catalyst was obtained.

The preparation for photocatalytic single-molecule redox reaction of single-particle of the BiVO₄/Ag₂O by structured illumination, comprising: first, dispersing BiVO₄/Ag₂O in absolute ethanol, ultrasonically dispersing evenly, and then dropping on a cleaned cover glass, and transferring to an oven at 80° C. for drying for 1 h to fix the particles; taking a glass slide and punching hole, fixing plastic micro-tubes in that holes by glue, stick double-sided adhesive on the glass slide and etching channels, and sticking the exposed surface of the particle on the cover glass and the glass slide to form a micro-channel reaction pool; then, fixing the reaction pool on a stage of a fluorescence microscope, and pumping solution in a probe into the micro-channel reaction pool by a micro-syringe pump.
3) Structured light irradiating catalyst to trigger photocatalytic redox reaction. Firstly, finding mono-disperse BiVO₄/Ag₂O particles under a bright field, and then irradiating the BiVO₄/Ag₂O particle with the 405 nm structured light to excite the BiVO₄/Ag₂O particle to generate electrons and holes. According to the semiconductor physics theory, the excitation rate of photogenerated carriers is proportional to the excitation intensity. Therefore, under the irradiation of structured light, the carrier concentration in the strong light region is high, and the carrier concentration in the weak light region is low. Under the action of concentration gradient force, the carrier concentration of high concentration diffuses to the low concentration region. For the BiVO₄/Ag₂O, the diffusion of free electrons is mainly considered. After reaching the steady state, net positive charges are left in the strong light region, and net negative charges are left in the weak light region. The formation of space charge field can effectively promote the spatial separation of photogenerated carriers. It should be pointed out that the space charge field formed here is determined by the spatial structure of the illumination light field, and the position, quantity, width and depth of the charge field can be accurately controlled by adjusting the structured light. Particularly, since light can be irradiated into the interior of the catalyst, a space charge field is also formed in the interior, so that bulk carriers can be separated efficiently. This carrier space separation mechanism driven by structured light illumination is not possessed by the traditional uniform illumination photocatalytic system. As shown in FIG. 5, it is a schematic diagram of the structured light illumination promoting separation of photogenerated electrons and holes of in the interior and surface of the catalyst in space disclosed in the present invention.

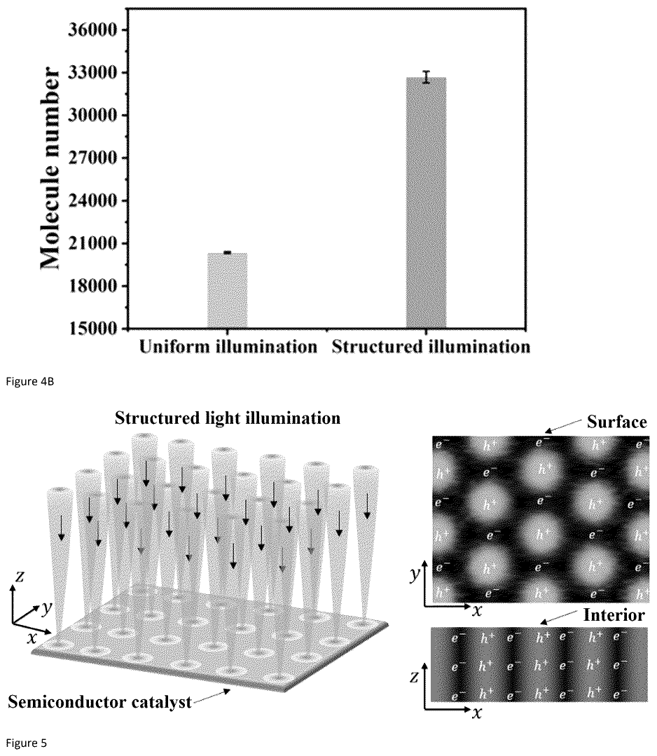

The electrons and holes generated by illumination can react with the reactants adsorbed on the surface of the particles in reduction and oxidation reactions respectively. In the present example, hydroxyphenylfluorescein (HPF) is used as a reactant for the oxidation reaction, and the HPF itself is non-fluorescent, but the oxidation reaction product thereof emits green fluorescence with a center wavelength of 515 nm under excitation by 488 nm laser light. In the present example, Resazurin is used as a reactant for the reduction reaction, and the Resazurin itself is non-fluorescent, but the reduced product thereof emits yellow fluorescence at a center wavelength of 590 nm under irradiation with a 561 nm lase. These single-molecule fluorescence signals are collected by a large numerical aperture oil-immersion objective lens and finally imaged by a camera via a dichroic mirror.
4) Using localization software to analyze the collected single-molecule images and localize single molecule burst frequency and spatial distribution, and compared with the case of uniform light irradiation under the same conditions. As shown in FIG. 4, the structured light illumination significantly enhanced the burst frequency and reaction rate of the catalytic oxidation of HPF (hole reaction) and the catalytic reduction of Resazurin (electron reaction) of BiVO₄/Ag₂O.

Although the specific examples of the present invention are described above in combination with the accompanying drawings, it is not a limitation on the protection scope of the present invention. Those skilled in the art should understand that on the basis of the technical scheme of the present invention, various modifications or deformations that can be made by those skilled in the art without creative labor are still within the protection scope of the present invention.

1. A device of photocatalytic redox reaction based on structured light illumination, comprising:
a computer module, being configured to send control instructions to a structured light generation module and an image acquisition module, to control generations of a structured illumination field and a total internal reflection illumination field, and acquisition of images of single-molecule fluorescence;
the structured light generation module, comprising a plurality of lasers, an acousto-optic tunable filter (AOTF) and a spatial light modulator (SLM), and being configured to control the plurality of lasers, the AOTF and the SLM according to the control instructions sent by the computer module, to generate and regulate the structured illumination field for exciting a photocatalytic redox reaction, and generate and regulate the total internal reflection illumination field for exciting the single-molecule fluorescence; and
the image acquisition module, being configured to acquire images of fluorescence signals in a process of the photocatalytic redox reaction.

2. The device according to claim 1, wherein the computer module sends synchronization signals generated by a synchronization controller to the structured light generation module and the image acquisition module, to synchronize the structured light generation module and the image acquisition module.

3. The device according to claim 1, wherein the structured light generation module comprises a first optical path formed by sequentially connecting a first light-source submodule comprising a first laser, a first reflecting mirror, a first dichroic mirror, a second reflecting mirror, and a second dichroic mirror connected sequentially, and the AOTF, a half-wave plate, a third dichroic mirror, a first polarization beam splitter prism, the SLM, a first lens, a third reflecting mirror, a fourth reflecting mirror, a second lens, a fifth reflecting mirror, a second polarization beam splitter prism, a first tube mirror, a fourth dichroic mirror, an objective lens and a photocatalytic redox reaction pool; wherein, the first light path is used for generating and regulating the structured illumination field and triggering the photocatalytic redox reaction in the photocatalytic redox reaction pool.

4. The device according to claim 3, wherein the structured light generation module further comprises a second optical path formed by sequentially connecting a second light-source submodule comprising a second laser, the first dichroic mirror, the second reflecting mirror, and the second dichroic mirror connected sequentially, and the AOTF, the half-wave plate, the third dichroic mirror, a sixth reflecting mirror, a seventh reflecting mirror, the first tube mirror, the fourth dichroic mirror, the objective lens and the photocatalytic redox reaction pool; wherein the second optical path is used for generating and regulating the total internal reflection illumination field.

5. The device according to claim 4, wherein the structured light generation module further comprises a third optical path formed by sequentially connecting a third light-source submodule comprising a third laser and the second dichroic mirror connected sequentially, and the AOTF, the half-wave plate, the third dichroic mirror, the sixth reflecting mirror, the seventh reflecting mirror, the first tube mirror, the fourth dichroic mirror, the objective lens and the photocatalytic redox reaction pool; wherein, the third optical path is used for generating and regulating the total internal reflection illumination field for exciting fluorescent molecules in the reactants or the products; wherein, wavelengths of the total internal reflection illumination field generated by the third optical path and the second optical path are not consistent.

6. The device according to claim 1, wherein the synchronization controller sends a triggering signal to the SLM, the SLM loads a phase modulation function stored in a storage module inside the SLM according to a predetermined timing sequence, and outputs a synchronous control signal to the synchronous controller, and then the computer module generates signals to a camera and the lasers based on the synchronous control signal received by the synchronous controller, to carry out sample excitation and image acquisition.

7. The device according to claim 1, wherein the image acquisition module comprises a fourth optical path formed by sequentially connecting the photocatalytic redox reaction pool, the objective lens, the fourth dichroic mirror, a second tube lens and an image detector; wherein, the objective lens, the fourth dichroic mirror and the second tube mirror are structures in an inverted microscope.

8. The device according to claim 5, wherein the first light-source submodule, the second light-source submodule, the third light-source submodule and the AOTF constitute a multi-wavelength laser light-source module, and an intensity and an illumination time sequence of a multi-wavelength laser beam comprising laser lights with different wavelengths and being generated by the multi-wavelength laser light-source module are adjusted by the AOTF; and
the AOTF outputs the multi-wavelength laser beam after intensity adjustment to the third dichroic mirror for separating the laser lights with different wavelengths; wherein
one wavelength of laser light is separated out and enters vertically the SLM through the first polarization beam splitter prism for modulating, and the modulated laser light is used to generate the structured light; and remaining wavelengths of laser lights maintain a uniform light state without being modulated.

9. The device according to claim 8, wherein the modulated laser light enters the image acquisition module through the first optical path of the structured light generation module after modulation, to form a structured illumination field near an object plane of a microscope, and irradiates a catalyst to generate electrons and holes to trigger the photocatalytic redox reaction.

10. The device according to claim 9, wherein in the photocatalytic redox reaction, at least one reactant or product is a fluorescent substance, the fluorescent substance may emit fluorescence by exciting by the total internal reflection illumination light, the microscope collects the emitted fluorescence and generate fluorescence signals, and transmits the generated fluorescence signals to the image detector through the fourth dichroic mirror and the second tube mirror, to form fluorescence images of a single-molecule redox reaction.

11. A working method of a device of photocatalytic redox reaction based on structured light illumination according to claim 1, comprising:
placing a particulate semiconductor catalyst and a reactant in an object space of a microscope and contacting the catalyst and the reactant;
irradiating the catalyst by a structured light generated by a structured light generation to trigger a photocatalytic redox reaction; and
exciting the reactant or reaction products to emit fluorescence, collecting single-molecule fluorescence signals through an image acquisition module and outputting images.
